(19) United States
(12) Patent Application Publication
(10) Pub. No.: US 2024/0391068 A1
(43) Pub. Date: Nov. 28, 2024

(54) POWERED FASTENING TOOL INCLUDING DRIVER RETURN SYSTEM AND DRIVER RETENTION SYSTEM

(71) Applicant: Black & Decker Inc., New Britain, CT (US)

(72) Inventors: Jillian TAKENO, Catonsville, MD (US); Robert J. OPSITOS, JR., New Freedom, PA (US); James D. SCHROEDER, Dallastown, PA (US); Daniel HEGARTY, Baltimore, MD (US); Larry E. GREGORY, Baltimore, MD (US); Matthew DARNALL, New Britain, CT (US)

(73) Assignee: Black & Decker Inc., New Britain, CT (US)

(21) Appl. No.: 18/693,729

(22) PCT Filed: Sep. 22, 2022
(86) PCT No.: PCT/US2022/044378

§ 371 Date: Mar. 20, 2024

Related U.S. Application Data
(60) Provisional application No. 63/247,112, filed on Sep. 22, 2021.
(60) Provisional application No. 63/247,298, filed on Sep. 22, 2021.

(51) Int. Cl. B25B 23/04; B25B 21/00

(52) U.S. Cl. CPC B25B 23/045; B25B 21/00

(57) ABSTRACT

A powered fastening tool (10) includes a fastener driver (28), a driver return system (64) and a driver retention system (66); the fastener driver (28) is configured to move from a home position to an extended position to drive a fastener (F) into a workpiece; the driver return system (64) is configured to return the fastener driver (28) from the extended position to the home position, the driver return system (64) includes an electric motor (76), a conveyor (80) driven by the electric motor (76) and a pawl (82) attached to the conveyor (80) and configured to engage the fastener driver (28); the driver retention system (66) is configured to retain the fastener driver (28) in the home position and the driver retention system (66) including a first detent spring (110) configured to engage the fastener driver (28) and thereby inhibit the fastener driver (28) from moving out of the home position.

### CROSS-REFERENCE TO RELATED APPLICATIONS

This application is a PCT International Application that claims the benefit of U.S. Provisional Application No. 63/247,112, filed on Sep. 22, 2021, and U.S. Provisional Application No. 63/247,298, filed on Sep. 22, 2021. The entire disclosure of each of the above applications is incorporated herein by reference.

### FIELD

The present disclosure relates to powered fastening tools including a driver return system and a driver retention system.

### BACKGROUND

This section provides background information related to the present disclosure which is not necessarily prior art.

Different types of fastening tools are known including portable pneumatically actuated devices, electrically actuated devices, hammer actuated devices, manual actuated devices, etc. Fastening tools, such as power nailers have become relatively common place in the construction industry. Battery-powered nailers are popular in the market.

A common characteristic of all these types of fastening tools is the provision of a drive track, a fastener driving element mounted in the drive track and a magazine assembly for receiving a supply of fasteners in stick formation and feeding successive leading fasteners in the stick laterally into the drive track to be driven outwardly thereof by the fastener driving element.

Electrically powered fastening tools typically include a rotating flywheel that engages a driver to impart energy to the driver, causing the driver to move and drive or deform the fastener. Thus, a drive motor assembly can include an electric motor coupled to the flywheel to rotate the flywheel without engaging the driver. When activated, the drive motor assembly causes the rotating flywheel and driver to engage each other to propel the driver from the returned position to the extended position. In a cordless electric nailer, for example, fasteners, such as nails, are driven into a workpiece by a driver blade or driver through a process known as a “drive” or “drive cycle”. Generally, a drive cycle involves the driver striking a fastener head during a drive stroke to an extended position and returning to a home or returned position during a return stroke. The structure of the drive motor assembly can result in changes in the attack angle or other changes that affect the efficiency with which the energy is transferred from the flywheel to the driver as the driver wears over the life of the tool.

Powered fastening tools can include a driver return system. Typically, such driver return mechanisms include compression return springs mounted on guide rails along which the driver moves. These compression return springs are compressed during the drive stroke and operate to return the driver during the return stroke. Such compression return springs experience extremely high dynamic loading forces as the profile is accelerated and decelerated in driving a nail. For example, in some cases a driver profile can accelerate from zero to 23 meters per second in about 4 milliseconds. As a result, return springs of such a driver profile generate problematic surge velocity waves which are highly detrimental to a desired long fatigue life of the springs. In addition, the room that is required along the drive rails to accommodate the compressed spring at the end of the drive stroke, can limit the ability to shorten the length of the tool in the direction of the diver axis.

Cordless nailers typically use some form of a driver, such as a driver blade, to drive a nail into the workpiece. The driver can be propelled forward by a flywheel during the nail firing process. The driver must be returned to its original home position in order to be ready for the following fastener drive action. This return system must be automatic, quick, durable, reliable, and be contained within the tool.

Once the driver is returned to its home position, the driver must be maintained in its home position to be ready for the following fastener drive action. The retention system must retain the driver with sufficient force to prevent inadvertent movement of the driver out of its home position. Conversely, the force needed to move the driver into its home position must be sufficiently low to enable to the driver return system to accomplish that task and to minimize wear on the driver return systems.

Accordingly, there remains a need to improve powered fastening tools to address the problems identified above or to address other problems of driver return systems and driver retention systems.

### SUMMARY

This section provides a general summary of the disclosure and is not a comprehensive disclosure of its full scope or all of its features.

An example of a driver return system for a powered fastening tool is described herein. The driver return system includes an electric motor, a conveyor driven by the electric motor, and a pawl attached to the conveyor. The pawl is configured to move a fastener driver of the powered fastening tool from an extended position to a home position when the electric motor is activated.

In one aspect, the conveyor forms an elongated loop having a longitudinal axis configured to be parallel to a path of the fastener driver.

In one aspect, the conveyor includes a chain.

In one aspect, the driver return system further includes a gear train that couples the electric motor to the chain.

In one aspect, the gear train includes a pinion gear and a first sprocket, the pinion gear is attached to the electric motor, and the first sprocket is coupled to the pinion gear and meshed with the chain. The first sprocket drives the chain when the electric motor is activated.

In one aspect, the gear train further includes an intermediate gear meshed with the pinion gear and attached to the first sprocket, the first sprocket is meshed with the chain at a first end of a loop formed by the chain, and the driver return system further includes a second sprocket meshed with the chain at a second end of the loop opposite of the first end.

In one aspect, after the pawl moves the fastener driver from the extended position to the home position, the conveyor moves the pawl out of a path of the fastener driver.

An example of a driver retention system for a powered fastening tool is also described herein. The driver retention system includes a first base plate and a first detent spring coupled to the first base plate. The first detent spring has a first inclined surface and a second inclined surface that cooperates with the first inclined surface to form a peak. The first inclined surface is configured to engage a fastener driver of the powered fastener tool when the fastener driver is moved past the first detent spring toward a home position. The second inclined surface is configured to engage the fastener driver when the fastener driver is moved past the first detent spring toward an extended position.

In one aspect, the first detent spring is configured to deflect toward the first base plate when the fastener driver engages at least one of the first inclined surface, the second inclined surface, and the peak.

In one aspect, the first detent spring has a first end and a second end opposite of the first end, the first end of the first detent spring is fixed to the first base plate, and the second end of the first detent spring is coupled to the first base plate in a manner that allows the second end to move relative to the first base plate in a direction parallel to a path of the fastener driver.

In one aspect, the first end of the first detent spring is fastened to the first base plate, and the second end of the first detent spring forms a hook that wraps around an edge of the first base plate without being fastened to the first base plate.

In one aspect, the first base plate has a planar surface, the first inclined surface of the first detent spring is oriented at a first angle with respect to the planar surface of the first base plate, the second inclined surface of the first detent spring is oriented at a second angle with respect to the planar surface of the first base plate, and the second angle is different than the first angle.

In one aspect, the driver retention system further includes a second base plate and a second detent spring coupled to the second base plate. The first and second detent springs are configured to be located on opposite sides of the fastener driver.

In one aspect, the driver retention system further includes an end cap including an end plate configured to retain a guide rail for the fastener driver and a pair of side plates extending from opposite sides of the end plate. The first base plate is attached to one of the side plates. The second base plate is attached to the other one of the side plates.

An example of a powered fastening tool is also described herein. The powered fastening tool includes a fastener driver, a driver return system, and a drier retention system. The fastener driver is configured to move from a home position to an extended position to drive a fastener into a workpiece. The driver return system is configured to return the fastener driver from the extended position to the home position. The driver return system includes an electric motor, a conveyor driven by the electric motor, and a pawl attached to the conveyor and configured to engage the fastener driver. The driver retention system is configured to retain the fastener driver in the home position. The driver retention system includes a first detent spring configured to engage the fastener driver and thereby inhibit the fastener driver from moving out of the home position.

In one aspect, the conveyor includes a chain, and the driver return system further includes a gear train that couples the electric motor to the chain.

In one aspect, the gear train includes a pinion gear and a sprocket, the pinion gear is attached to the electric motor, and the sprocket is coupled to the pinion gear and meshed with the chain. The sprocket drives the chain when the electric motor is activated.

In one aspect, the first detent spring has a first inclined surface and a second inclined surface that cooperates with the first inclined surface to form a peak. The first inclined surface engages the fastener driver when the fastener driver is moved past the first detent spring toward the home position. The second inclined surface engages the fastener driver when the fastener driver is moved past the first detent spring toward the extended position.

In one aspect, the driver retention system further includes a base plate. One end of the first detent spring is fixed to the base plate, and the other end of the first detent spring is coupled to the base plate in a manner that allows the other end to move relative to the base plate in a direction parallel to a path of the fastener driver.

In one aspect, the powered fastening tool further includes a guide rail along which the fastener driver moves, and the driver retention system further includes a second detent spring and an end cap. The second detent spring is configured to engage the fastener driver and thereby inhibit the fastener driver from moving out of the home position. The end cap retains one end of the guide rail and positions the first and second detent springs on opposite sides of the fastener driver.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevation view of an example of a powered fastening tool according to the present disclosure;

FIG. 2 is a schematic view of a portion of the powered fastening tool of FIG. 1 illustrating various components including a driver motor assembly and a controller;

FIG. 3 is a perspective view of a portion of the powered fastening tool of FIG. 1 illustrating various components including a driver return system and a driver retention system;

FIG. 4 is a perspective view of the driver return system of FIG. 3.

FIG. 5 is a side elevation view of the driver return system of FIG. 3;

FIG. 6 is a perspective view of the driver retention system of FIG. 3;

FIG. 7 is a cross-sectional view of the driver retention system of FIG. 3; and

FIG. 8 is a top perspective view of the driver retention system of FIG. 3.

Corresponding reference numerals indicate corresponding parts throughout the several views of the drawings.

### DETAILED DESCRIPTION

Example embodiments will now be described more fully with reference to the accompanying drawings.

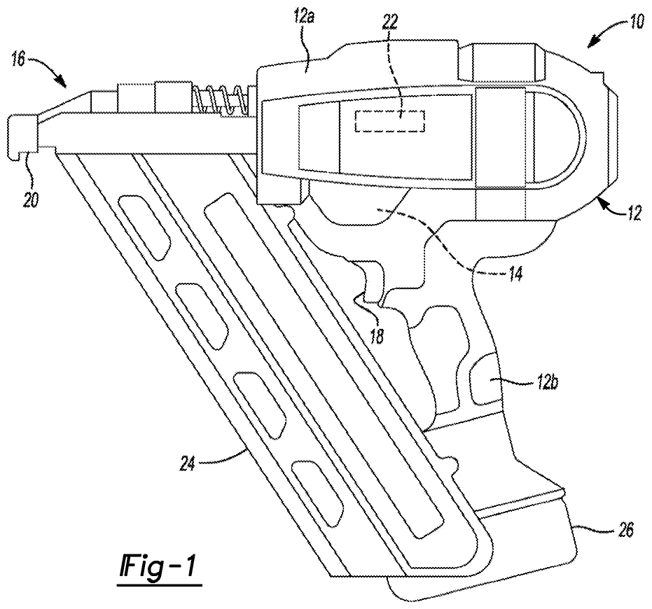

Referring now to FIG. 1, a fastening tool 10 according to the present disclosure includes a housing 12, a driver assembly 14, a nosepiece assembly 16, a trigger 18, a contact trip 20, a control module 22, a magazine 24, and a battery 26. The battery 26 provides electrical power to the various sensors (which are discussed in detail, below) as well as the driver assembly 14 and the control module 22. Those skilled in the art will appreciate from this disclosure, however, that in place of, or in addition to the battery 26, the fastening tool 10 may include an external power cord (not shown) for connection to an external power supply (not shown). Thus, the fastening tool 10 is electrically powered by a suitable electric power source or electric energy storage device, such as the battery 26.

The housing 12 includes a body portion 12a, which houses the driver assembly 14 and the control module 22, and a handle 12b. The handle 12b provides the housing 12 with a conventional pistol-grip appearance and may be unitarily formed with the body portion 12a or may be a discrete fabrication that is coupled to the body portion 12a, as by threaded fasteners (not shown). The handle 12b may be contoured so as to ergonomically fit a user's hand and/or may be equipped with a resilient and/or non-slip covering, such as an overmolded thermoplastic elastomer.

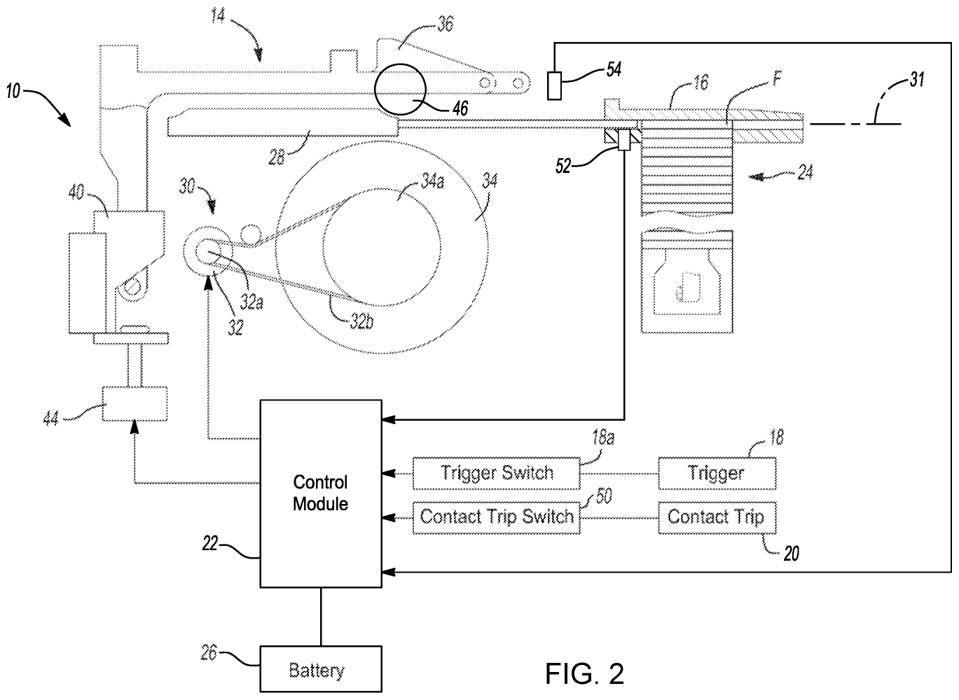

With additional reference to FIG. 2, the driver assembly 14 includes a driver 28 and a power source 30 that is configured to selectively transmit power to the driver 28 to cause the driver 28 to translate along an axis 31 from a home position, shown in FIG. 2, to an extended position. In the example provided, the power source 30 includes an electric motor 32, a flywheel 34, which is coupled to an output shaft 32a of the motor 32, a pinch roller assembly 36, and an actuator 44. In operation, fasteners F are stored in the magazine 24, which sequentially feeds the fasteners F into the nosepiece assembly 16.

The power source 30 is controlled by the control module 22 to cause the driver 28 to translate and impact a fastener F in the nosepiece assembly 16 so that the fastener F may be driven from the nosepiece assembly 16 and into a workpiece (not shown). Activation of the power source 30 utilizes electrical energy from the battery 26 to operate the motor 32 and the actuator 44. The motor 32 is employed to drive the flywheel 34, while the actuator 44 is employed to move a roller 46 that is associated with the roller assembly 36. The motor 32 can be drivingly coupled to the flywheel 34 in any suitable manner.

In the example provided, the motor 32 is drivingly coupled to the flywheel 34 via a belt 32b drivingly coupled to the output shaft 32a of the motor 32 and an input 34a of the flywheel 34. In an alternative construction, not specifically shown, the motor 32 can be directly connected to the flywheel 34. For example, the motor 32 can be an inside-out or outer-rotor brushed or brushless motor, having the rotor of the motor 32 disposed about the stator coils of the motor 32. In such a configuration, the rotor of the motor 32 can be integrally formed with or fixedly coupled to the flywheel 34 for common rotation about the stator of the motor 32.

Returning to the example provided, the roller assembly 36 presses the driver 28 into engagement with the flywheel 34 so that mechanical energy is transferred from the flywheel 34 to the driver 28 to cause the driver 28 to translate along the axis 31. The nosepiece assembly 16 guides the fastener F as it is being driven into the workpiece (not shown).

The trigger 18 is coupled to the housing 12 and is configured to receive an input from the user, typically by way of the user's finger, which may be employed in conjunction with a trigger switch 18a to generate a trigger signal. The trigger signal may be employed in whole or in part to initiate the cycling of the fastening tool 10 to install a fastener F to a workpiece (not shown).

The contact trip 20 may be coupled to the nosepiece assembly 16 for sliding movement thereon. The contact trip 20 is configured to slide rearwardly in response to contact with a workpiece (not shown) and may interact either with the trigger 18 or a contact trip sensor or switch 50. In the former case, the contact trip 20 cooperates with the trigger 18 to permit the trigger 18 to actuate the trigger switch 18a to generate the trigger signal. More specifically, the trigger 18 may include a primary trigger, which is actuated by a finger of the user, and a secondary trigger, which is actuated by sufficient rearward movement of the contact trip 20. Actuation of either one of the primary and secondary triggers will not, in and of itself, cause the trigger switch 18a to generate the trigger signal. Rather, both the primary and the secondary trigger must be placed in an actuated condition to cause the trigger switch 18a to generate the trigger signal.

In the latter case (i.e., where the contact trip 20 interacts with the contact trip switch 50), which is employed in the example provided, rearward movement of the contact trip 20 by a sufficient, predetermined amount causes the contact trip switch 50 to generate a contact trip signal, which may be employed in conjunction with the trigger signal to initiate the cycling of the fastening tool 10 to install a fastener F to a workpiece.

The control module 22 may control the motor 32 and/or the actuator 44 based on inputs from a sensor 52 and a sensor 54. Each of the sensors 52, 54 may be a proximity sensor or a mechanical switch. The sensors 52, 54 are discussed in more detail below.

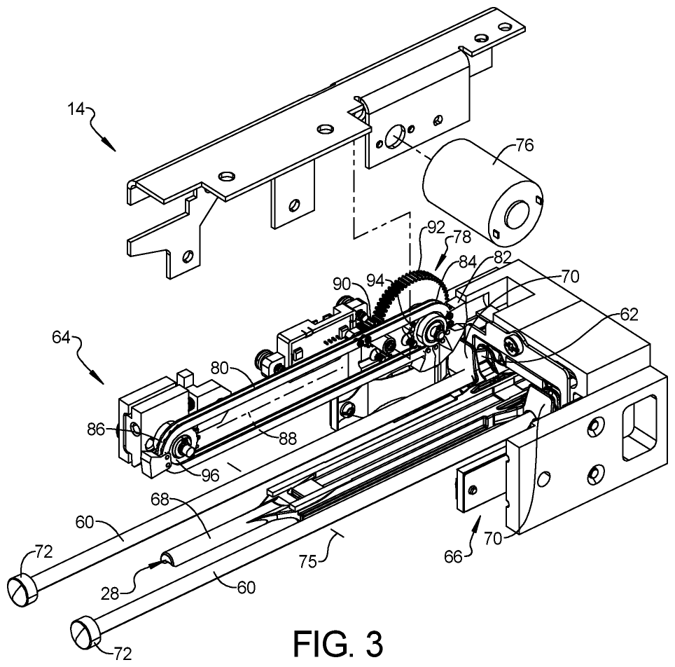

Referring now to FIG. 3, the driver assembly 14 further includes guide rails 60, a rear bumper 62, a driver return system 64, and a driver retention system 66. The driver return system 64 is operable to return the driver 28 from its extended position to its home position. Once the driver 28 has been returned to its home position, the driver retention system 66 is configured to retain the driver 28 in its home position. The driver 28 may be made of steel or titanium, and the guide rails 60 may be made of steel.

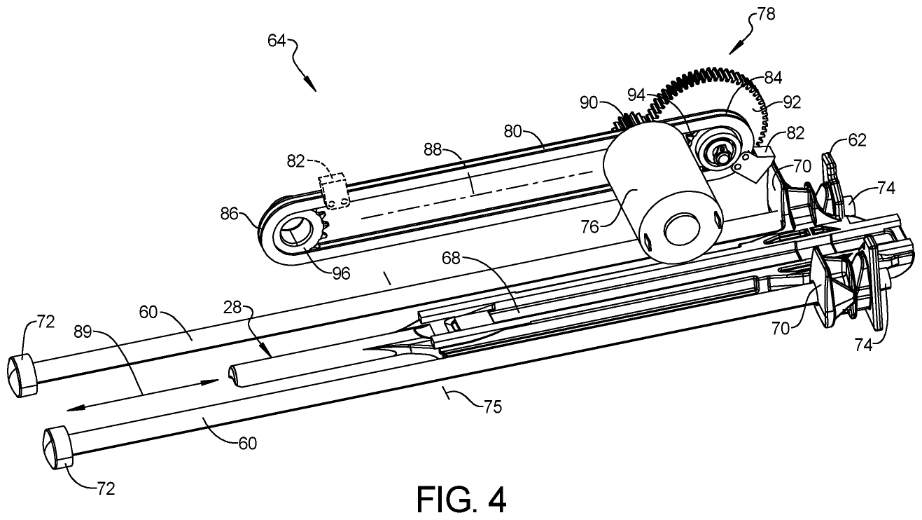

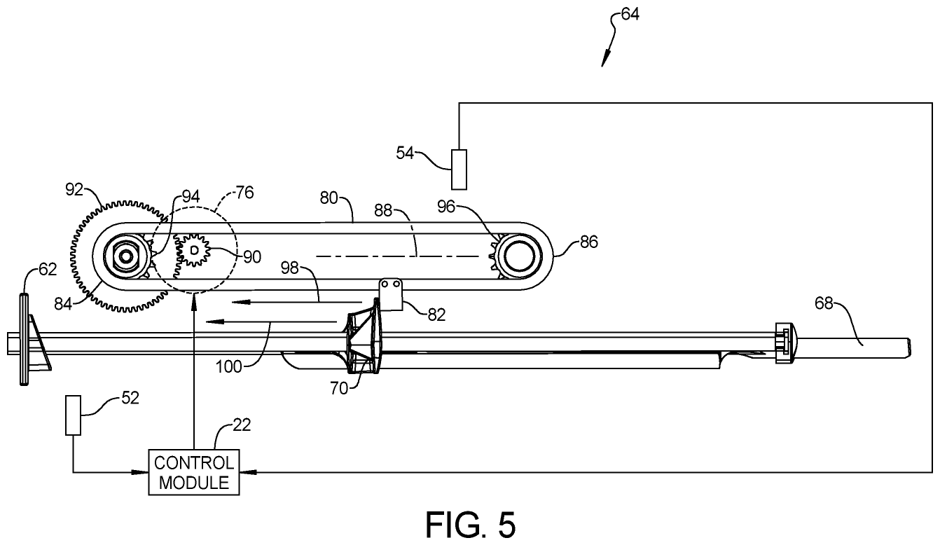

With additional reference to FIGS. 4 and 5, the driver 28 includes a blade 68 and ears 70 projecting from the blade 68, and each guide rail 60 has a front end 72 and a rear end 74. The rear bumper 62 acts as a stop by engaging the ears 70 of the driver 28 to prevent the driver 28 from moving rearward (i.e., toward the rear ends 74 of the guide rails 60) past its home position. The rear bumper 62 is attached to the guide rails 60 at or adjacent to the rear ends 74 thereof. The driver assembly 14 may also include a front bumper (not shown) that acts as a stop by engaging the ears 70 of the driver 28 to prevent the driver 28 from moving forward (i.e., toward the front ends 72 of the guide rails 60) past its extended position. The front bumper may be attached to the guide rails 60 at a location 75 between the front end 72 and rear end 74 of the guide rails 60.

The driver return system 64 includes an electric motor 76, a gear train 78, a conveyor 80, and a pawl 82. The gear train 78 couples the motor 76 to the conveyor 80. The motor 76 drives the conveyor 80 via the gear train 78 when the motor 76 is activated, and the motor 76 does not drive the conveyor 80 when the motor 76 is deactivated. The conveyor 80 forms a continuous, elongated loop having a rear end 84, a front end 86, and a longitudinal axis 88 extending between the rear and front ends 84 and 86. The longitudinal axis 88 of the conveyor 80 is parallel to a path 89 of the driver 28.

The gear train 78 includes a pinion gear 90, an intermediate gear 92, and a sprocket 94. The pinion gear 90 is attached to the motor 76 so that the motor 76 rotates the pinion gear 90 when the electric motor is activated. The intermediate gear 92 is meshed with the pinion gear 90 and attached to the sprocket 94. The sprocket 94 is coupled to the pinion gear 90 via the intermediate gear 92, and the sprocket 94 is meshed with the conveyor 80 at the rear end 84 of the loop formed by the conveyor 80. The sprocket 94 drives the conveyor 80 when the motor 76 is activated. The driver return system 64 further includes a non-driven sprocket 96 meshed with the conveyor 80 at the front end 86 of the loop formed by the conveyor 80. The gear train 78, the conveyor 80, and the sprocket 96 may be made of metal (e.g., steel, powdered metal) or plastic and may be stamped, forged, casted, or molded.

The pawl 82 is attached to the conveyor 80 so that when the motor 76 drives the conveyor 80, the pawl 82 moves with the conveyor 80 along a path 98 (FIG. 5) that causes the pawl 82 engage the driver 28 and return the driver 28 to its home position. In the example shown, the pawl 82 is attached to the conveyor 80 using a fastener (e.g., rivets, pins with C-clips), and the conveyor 80 is a chain. In other examples, the conveyor 80 may be or include a belt, one or more linkages, or another mechanism configured to move the pawl 82 along the path 98 to return the driver 28 to its home position. In various implementations, the pawl 82 may be directly attached to the gear train 78, and the gear train 78 may act as a conveyor. In these implementations, the conveyor 80 may be omitted.

The conveyor 80 is positioned above a path 100 of one of the ears 70 of the driver blade 68, with the path 98 of the pawl 82 overlapping the majority of the path 100 of the driver blade ear 70. After the driver blade 68 has been propelled forward and has driven a fastener, such as a nail, the driver return system 64 is activated, the conveyor 80 rotates, and the pawl 82 travels along its path 98 until interfacing with the front of the driver blade ear 70. The pawl 82 continues to move, pushing the driver blade 68 back along with it, toward the driver blade home position. Once the driver blade 68 is in its home position, the path 98 of the pawl 82 diverts upward and out of the path 100 of the driver blade ear 70. The motor 76 is then no longer powered, and the conveyor 80 stops moving and the pawl 82 remains stationary out of the path 100 of the driver blade ear 70 when the driver 28 is driving a fastener.

With particular reference to FIG. 5, when the motor is activated, the shaft rotates counterclockwise from the perspective shown. The attached first gear then rotates counterclockwise, and it is meshed with the larger second gear. The larger second gear is attached to a sprocket that the chain is wrapped around, so both the second gear and sprocket rotate clockwise once the motor is powered. This pulls the chain around the sprocket in this same motion (clockwise). This pulls the pawl back toward its home position (to the left, in the image) when interacting with the driver blade.

The control module 22 activates and deactivates the motor 76 and may adjust the speed of the motor 76. The control module 22 may activate the motor 76 to move the pawl 82 along its path 98 and return the driver 28 to its home position when a predetermined amount of time has elapsed since the trigger switch 18a detected that the trigger 18 was pulled. Additionally, or alternatively, the control module 22 may activate the motor 76 to return the driver 28 to its home position when the sensor 52 detects that the driver 28 is not in its home position.

The control module 22 may deactivate the motor 76 when a predetermined amount of time has elapsed since the control module 22 activated the motor 76. Additionally, or alternatively, the control module 22 may deactivate the motor 76 when the sensor 54 detects that the pawl 82 is in its home position out of the path 100 of the driver blade ear 70. The pawl 82 is represented using phantom lines in FIG. 4 to show the pawl 82 in its home position, and the pawl 82 represented using solid lines in FIG. 4 to show the position of the pawl 82 when the driver 28 is initially returned its home position. The internal resistance of the motor 76 may keep the pawl 82 in its home position until the motor 76 is activated to move the pawl 82 along its path 98.

In various implementations, the driver return system 64 may include two pawls 82. For example, the pawl 82 represented using solid lines and the pawl 82 represented using phantom lines may both be attached to the conveyor 80. In turn, the conveyor 80 only needs to travel through the path 98 one-half as the amount that the conveyor 80 needs to travel through the path 98 if only one pawl 82 is included.

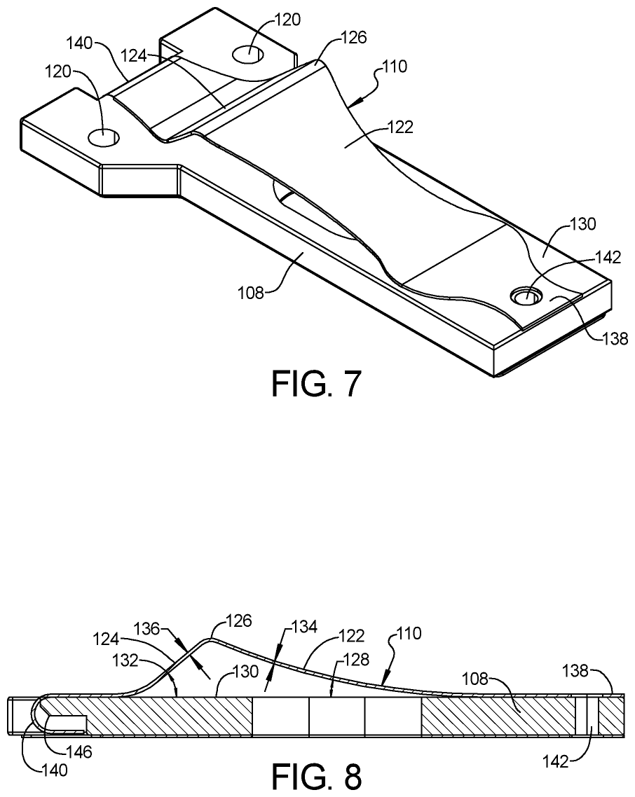

Referring now to FIGS. 3, 6, 7, and 8, the diver assembly 14 further includes an end cap 104 and a mounting bracket 106, and the driver retention system 66 includes a pair of holders or base plates 108 and a pair of detent springs 110. The end cap 104 may also be considered part of the driver retention system 66, and the mounting bracket 106 may be considered part of the end cap 104. The end cap 104 retains the rear ends 74 of the guide rails 60 and positions the detent springs 110 on opposite sides of the driver 28 so that each detent spring 110 is positioned in the path 100 of one of the driver blade ears 70. In turn, the detent springs 110 engage the driver blade ears 70 to inhibit the driver 28 from moving out of its home position.

Each detent spring 110 is coupled to one of the base plates 108. Each detent spring 110 may be made of steel (e.g., spring steel). The end cap 104, the mounting bracket 106, and the base plate 108 may also be made of steel. In various implementations, the driver retention system 66 may include only one of the detent springs 110 and only the one base plates 108 to which the one detent spring 110 is coupled. Additionally, or alternatively, both of the base plates 108 may be omitted, in which case the detent spring(s) 110 may be attached directly to the end cap 104.

The end cap 104 includes an end plate 112 and a pair of side plates 114 extending from opposite sides of the end plate 112. The mounting bracket 106 retains the rear ends 74 the guide rails 60 to the end plate 112 while allowing the rear ends 74 to move in a vertical direction 116 relative to the end cap 104. One of the base plates 108 is attached to one of the side plates 114 of the end cap 104, and the other one of the base plates 108 is attached to the other one of the side plates 114 of the end cap 104. In the example shown, the base plates 108 are attached to the side plates 114 of the end cap 104 using fasteners 118 that extend through holes 120 in the base plates 108.

Each detent spring 110 has an inclined surface 122 and an inclined surface 124 that cooperates with the inclined surface 122 to form a peak 126. The inclined surface 122 engages the driver 28 when the driver 28 is moved past the respective detent spring 110 toward its home position. The inclined surface 124 engages the driver 28 when the driver 28 is moved past the respective detent spring 110 toward its extended position. Each detent spring 110 deflects toward the base plate 108 to which the detent spring 110 is coupled when the driver 28 engages the inclined surface, 122, the inclined surface 124, and/or the peak 126 of the detent spring 110.

The inclined surface 122 of each detent spring 110 is oriented at an angle 128 with respect to a planar surface 130 of the base plate 108 to which the detent spring 110 is coupled. The inclined surface 124 of each detent spring 110 is oriented at an angle 132 with respect to the planar surface 130 of the base plate 108 to which the detent spring 110 is coupled. In the example shown, the angle 132 is greater than the angle 128. The difference in the angles 128, 132 may yield different forces and/or different rates of forces to overcome the bias of the detent spring 110. In turn, the force and/or rate of force required to deflect the detent spring 110 to return the driver 28 to its home position may be less than the force and/or rate of force required to deflect the detent spring 110 to move the driver 28 out of its home position, such as when the driver 28 is actuated to drive a fastener.

In various implementations, the angle 132 of the inclined surface 124 of each detent spring 110 may be equal to the angle 128 of the inclined surface 122 of the same detent spring 110. Additionally, or alternatively, a thickness 134 or bias of each detent spring 110 along the inclined surface 122 may be less than a thickness 136 or bias of the same detent spring 110 along the inclined surface 124. The differences in the thicknesses 134, 136 or biases of the detent spring 110 along the inclined surfaces 122, 124 may yield different forces and/or different rates of forces to overcome the bias of the detent spring 110. In turn, the force and/or rate of force that must be applied to the driver 28 to return the driver 28 to its home position may be less than the force and/or rate of force that must be applied to the driver 28 to move the driver out of its home position.

Each detent spring 110 has a front end 138 and a rear end 140. The front end 138 of each detent spring 110 is fixed to one of the base plates 108 using for example, a fastener 142 (e.g., a bolt). The rear end 140 of each detent spring 110 is coupled to the same base plate 108 in a manner that allows the rear end 140 move relative to the base plate 108 in a direction 144 parallel to the path 89 of the driver 28. In the example shown, the rear end 140 of each detent spring 110 forms a hook that wraps around an edge 146 of the base plate 108 without being fastened to the base plate 108. Thus, when the driver 28 engages the detent spring 110, the detent spring 110 can deflect while staying coupled to the base plate 108.

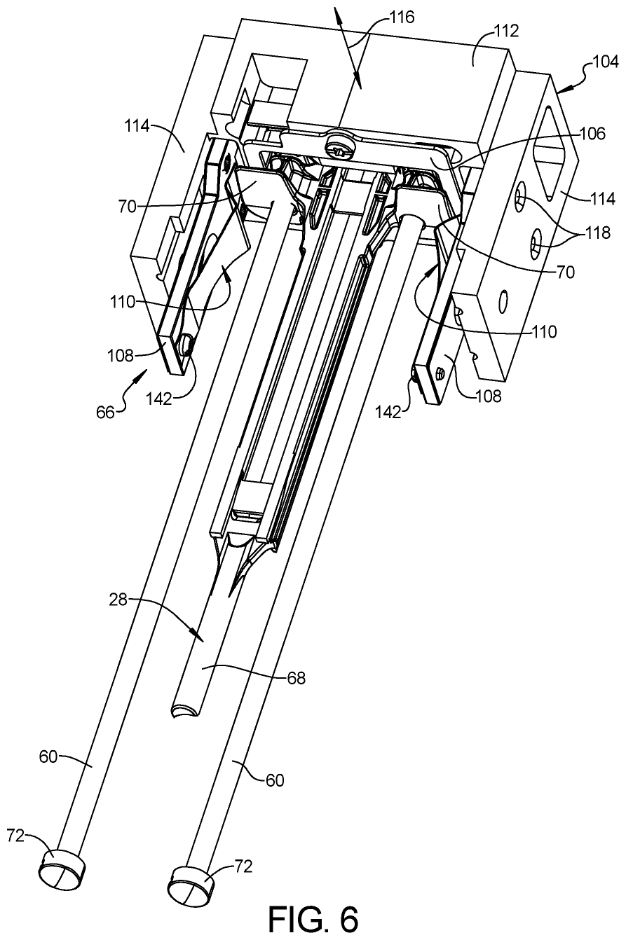

When the driver 28 is in the home position, illustrated in FIG. 6, an end portion of the driver 28 (e.g., the portion of the driver 28 including the ears 70) is disposed between the detent springs 110 and the closed end (e.g., the end cap 104) of the driver retention system 66 in a driver home position pocket. The detent springs 110 are shown holding and/or surrounding the driver blade ears 70 in the driver home position pocket. For the driver 28 to exit the home position pocket, a force or rate of force greater than the force or rate of force required to enter the home position pocket may be needed.

For the driver blade ears 70 or the driver 28 to pass by the detent springs 110, and enter or exit the home position pocket, an entering force and an exiting force, respectively, are required. In the fastener driving direction, the exiting force is applied, the magnitude or rate of the exiting force may be greater than the magnitude or rate of the entering force that places the driver blade ears 70 in the home position pocket. As a result, less force or rate of force may be required to place the driver 28 in the home position. At the same time, it may be more difficult for the driver 28 to bounce out of position or out of the home position inadvertently.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes any and all combinations of one or more of the associated listed items.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A driver return system for a powered fastening tool, the driver return system comprising:
an electric motor;
a conveyor driven by the electric motor; and
a pawl attached to the conveyor and configured to move a fastener driver of the powered fastening tool from an extended position to a home position when the electric motor is activated.

2. The driver return system of claim 1 wherein the conveyor forms an elongated loop having a longitudinal axis configured to be parallel to a path of the fastener driver.

3. The driver return system of claim 1 wherein the conveyor includes a chain.

4. The driver return system of claim 3 further comprising a gear train that couples the electric motor to the chain.

5. The driver return system of claim 4 wherein:
the gear train includes a pinion gear and a first sprocket;
the pinion gear is attached to the electric motor; and
the first sprocket is coupled to the pinion gear and meshed with the chain, the first sprocket driving the chain when the electric motor is activated.

6. The driver return system of claim 5 wherein:
the gear train further includes an intermediate gear meshed with the pinion gear and attached to the first sprocket;
the first sprocket is meshed with the chain at a first end of a loop formed by the chain; and
the driver return system further comprises a second sprocket meshed with the chain at a second end of the loop opposite of the first end.

7. The driver return system of claim 1 wherein after the pawl moves the fastener driver from the extended position to the home position, the conveyor moves the pawl out of a path of the fastener driver.

8. A driver retention system for a powered fastening tool, the driver retention system comprising:
a first base plate; and
a first detent spring coupled to the first base plate, the first detent spring having a first inclined surface and a second inclined surface that cooperates with the first inclined surface to form a peak, wherein:
the first inclined surface is configured to engage a fastener driver of the powered fastener tool when the fastener driver is moved past the first detent spring toward a home position; and
the second inclined surface is configured to engage the fastener driver when the fastener driver is moved past the first detent spring toward an extended position.

9. The driver retention system of claim 8 wherein the first detent spring is configured to deflect toward the first base plate when the fastener driver engages at least one of the first inclined surface, the second inclined surface, and the peak.

10. The driver retention system of claim 8 wherein:
the first detent spring has a first end and a second end opposite of the first end;
the first end of the first detent spring is fixed to the first base plate; and
the second end of the first detent spring is coupled to the first base plate in a manner that allows the second end to move relative to the first base plate in a direction parallel to a path of the fastener driver.

11. The driver retention system of claim 10 wherein:
the first end of the first detent spring is fastened to the first base plate; and
the second end of the first detent spring forms a hook that wraps around an edge of the first base plate without being fastened to the first base plate.

12. The driver retention system of claim 8 wherein:
the first base plate has a planar surface;
the first inclined surface of the first detent spring is oriented at a first angle with respect to the planar surface of the first base plate;
the second inclined surface of the first detent spring is oriented at a second angle with respect to the planar surface of the first base plate; and
the second angle is different than the first angle.

13. The driver retention system of claim 8 further comprising:
a second base plate; and
a second detent spring coupled to the second base plate, wherein the first and second detent springs are configured to be located on opposite sides of the fastener driver.

14. The driver retention system of claim 13 further comprising an end cap including an end plate configured to retain a guide rail for the fastener driver and a pair of side plates extending from opposite sides of the end plate, wherein:
the first base plate is attached to one of the side plates; and
the second base plate is attached to the other one of the side plates.

15. A powered fastening tool comprising:
a fastener driver configured to move from a home position to an extended position to drive a fastener into a workpiece;
a driver return system configured to return the fastener driver from the extended position to the home position, the driver return system including an electric motor, a conveyor driven by the electric motor, and a pawl attached to the conveyor and configured to engage the fastener driver; and
a driver retention system configured to retain the fastener driver in the home position, the driver retention system including a first detent spring configured to engage the fastener driver and thereby inhibit the fastener driver from moving out of the home position.

16. The powered fastening tool of claim 15 wherein:
the conveyor includes a chain; and
the driver return system further includes a gear train that couples the electric motor to the chain.

17. The powered fastening tool of claim 16 wherein:
the gear train includes a pinion gear and a sprocket;
the pinion gear is attached to the electric motor; and
the sprocket is coupled to the pinion gear and meshed with the chain, the sprocket driving the chain when the electric motor is activated.

18. The powered fastening tool of claim 15 wherein:
the first detent spring has a first inclined surface and a second inclined surface that cooperates with the first inclined surface to form a peak;
the first inclined surface engages the fastener driver when the fastener driver is moved past the first detent spring toward the home position; and
the second inclined surface engages the fastener driver when the fastener driver is moved past the first detent spring toward the extended position.

19. The powered fastening tool of claim 18 wherein:
the driver retention system further includes a base plate;
one end of the first detent spring is fixed to the base plate; and
the other end of the first detent spring is coupled to the base plate in a manner that allows the other end to move relative to the base plate in a direction parallel to a path of the fastener driver.

20. The powered fastening tool of claim 15 further comprising a guide rail along which the fastener driver moves, wherein:
the driver retention system further includes a second detent spring and an end cap;
the second detent spring is configured to engage the fastener driver and thereby inhibit the fastener driver from moving out of the home position; and
the end cap retains one end of the guide rail and positions the first and second detent springs on opposite sides of the fastener driver.
